(19) United States
(12) Patent Application Publication
(10) Pub. No.: US 2016/0072617 A1
(43) Pub. Date: Mar. 10, 2016

(54) RADIO BASE STATION, USER TERMINAL AND RADIO COMMUNICATION METHOD

(71) Applicant: NTT DOCOMO, INC., Tokyo (JP)

(72) Inventors: Satoshi Nagata, Tokyo (JP); Chunyi Wang, Beijing (CN); Xiaolin Hou, Beijing (CN); Atsushi Harada, Beijing (CN)

(73) Assignee: NTT DOCOMO, INC., Tokyo (JP)

(21) Appl. No.: 14/782,685

(22) PCT Filed: Mar. 24, 2014
(86) PCT No.: PCT/JP2014/058111

§ 371 Date: Oct. 6, 2015

(30) Foreign Application Priority Data
Apr. 12, 2013 (JP) 2013-084036

(51) Int. Cl. H04L 5/14; H04L 5/00; H04W 72/04

(52) U.S. Cl. CPC H04L 5/14; H04W 72/0406; H04W 72/0446; H04L 5/0055; H04W 88/08

(57) ABSTRACT

In order to provide feedback information of a transmission acknowledgement signal or the like appropriately even in change in DL/UL configuration in TDD, the present invention provides a radio base station that communicates with a user terminal by time division duplex and is capable of controlling change in DL/UL configuration. The radio base station includes: a determining section that determines feedback timing of a transmission acknowledgement signal of a DL subframe in a radio frame before change in DL/UL configuration; and a control section that controls a UL subframe to use in feedback of the transmission acknowledgement signal of the DL subframe, based on the feedback timing. When the transmission acknowledgement signal is to be fed back in a radio frame after change in DL/UL configuration, the control section reconfigures the UL subframe to use in feedback based on a feedback range covered by a UL subframe after change in DL/UL configuration.

### TECHNICAL FIELD

The present invention relates to a radio base station, a user terminal and a radio communication method applicable to next-generation communication systems.

### BACKGROUND ART

In a UMTS (Universal Mobile Telecommunications System) network, for the purposes of improving spectral efficiency and improving data rates, system features based on W-CDMA (Wideband Code Division Multiple Access) are maximized by adopting HSDPA (High Speed Downlink Packet Access) and HSUPA (High Speed Uplink Packet Access). For this UMTS network, for the purposes of further increasing data rates, providing low delay and so on, long-term evolution (LTE) has been studied and standardized (see Non Patent Literature 1).

In a third-generation system, it is possible to achieve a transmission rate of maximum approximately 2 Mbps on the downlink by using a fixed band of approximately 5 MHz. In an LTE system, it is possible to achieve a transmission rate of about maximum 300 Mbps on the downlink and about 75 Mbps on the uplink by using a variable band which ranges from 1.4 MHz to 20 MHz. In the UMTS network, successor systems to LTE have been also studied and standardized for the purposes of achieving further broadbandization and higher speed (for example, such a system is also called “LTE advanced” or “LTE enhancement” (hereinafter referred to as “LTE-A”)).

As duplex schemes in radio communication, there are frequency division duplex (TDD) of dividing uplink (UL) and downlink (DL) by frequency and time division duplex (TDD) of dividing uplink and downlink by time. For TDD, the same frequency domain is applied to uplink and downlink and signal transmission and reception is performed at one transmission/reception point by using different time sections between uplink and downlink.

In TDD of the LTE system, there are defined a plurality of frame configurations (DL/UL configurations) of which transmission rates are different between uplink subframes and downlink subframes (see FIG. 1). In the LTE system, as illustrated in FIG. 1, seven frame structures, DL/UL configurations 0 to 6, are defined and subframes #0 and #5 are assigned to downlink and subframe #2 is assigned to uplink. A transmission acknowledgement signal (HARQ) in response to a downlink shared channel (PDSCH) transmitted in each DL subframe is fed back using a predetermined UL subframe defined per DL/UL configuration.

### CITATION LIST

### Non-Patent Literature

Non-Patent Literature 1: 3GPP, TR25.912 (V7.1.0), “Feasibility study for Evolved UTRA and UTRAN”, September 2006

### SUMMARY OF INVENTION

### Technical Problem

Generally, the rate between DL traffic and UL traffic is not constant and varies depending on time and location. For example, when TDD is applied, the DL/UL configuration illustrated in FIG. 1 is not fixed, but preferably varies temporally or locationally in accordance with fluctuation of actual traffic.

Then, in TDD of LTE-A system (Rel. 12) or later, it has been studied to change the transmission rate between DL and UL subframes per transmission/reception point dynamically or semi-statically in time domain (Flexible TDD DL/UL time configuration scenario).

However, feedback information (transmission acknowledgement signal or the like) corresponding to each DL subframe is defined to be transmitted in a predetermined UL subframe. Therefore, if the DL/UL configuration is changed, but the feedback timing before change of the DL/UL configuration is used as it is, it may be difficult to transmit the transmission acknowledgement signal appropriately in a subframe after change of DL/UL configuration.

The present invention was carried out in view of the foregoing and aims to provide a radio base station, a user terminal and a radio communication method capable of transmitting feedback information of transmission acknowledgement signals or the like appropriately even with change in DL/UL configuration in TDD.

### Solution to Problem

The present invention provides a radio base station that communicates with a user terminal by time division duplex and is capable of controlling change in DL/UL configuration, the radio base station including a determining section that determines feedback timing of a transmission acknowledgement signal of a DL subframe in a radio frame before change in DL/UL configuration, and a control section that controls a UL subframe to use in feedback of the transmission acknowledgement signal of the DL subframe, based on the feedback timing, wherein, when the transmission acknowledgement signal is to be fed back in a radio frame after change in DL/UL configuration, the control section reconfigures the UL subframe to use in feedback based on a feedback range covered by a UL subframe after change in DL/UL configuration.

### Advantageous Effects of Invention

According to the present invention, it is possible to transmit feedback information such as transmission acknowledgement signals or the like appropriately even with change in DL/UL configuration in TDD.

### BRIEF DESCRIPTION OF DRAWINGS

FIG. 1 is a diagram for explaining an example of DL/UL configuration in TDD;

FIG. 2 provides diagrams illustrating an example of a radio communication system controlling the DL/UL configuration between neighboring radio base stations;

FIG. 3 provides diagrams illustrating an example of change in DL/UL configuration;

FIG. 4 provides diagrams illustrating an example of the feedback method of an uplink control signal of each DL subframe in accordance with change in DL/UL configuration;

FIG. 5 provides diagrams illustrating another example of the feedback method of an uplink control signal of each DL subframe in accordance with change in DL/UL configuration;

FIG. 6 provides diagrams for explaining the timing of feedback of a transmission acknowledgement signal of each DL subframe in a radio frame before change in DL/UL configuration;

FIG. 7 provides diagrams for explaining a feedback range (feedback window) covered by each UL subframe;

FIG. 8 is a diagram for explaining an example of the feedback method of a transmission acknowledgement signal of each DL subframe before change in DL/UL configuration, in accordance with change in DL/UL configuration;

FIG. 9 is a diagram for explaining another example of the feedback method of a transmission acknowledgement signal of each DL subframe before change in DL/UL configuration, in accordance with change in DL/UL configuration;

FIG. 10 is a diagram for explaining yet another example of the feedback method of a transmission acknowledgement signal of each DL subframe before change in DL/UL configuration, in accordance with change in DL/UL configuration;

FIG. 11 is a diagram illustrating an example of a timing table with DL subframes defined corresponding to each UL subframes in radio frames before and after change in DL/UL configuration;

FIG. 12 is a sequence diagram illustrating an example of the feedback operation of a transmission acknowledgement signal of each DL subframe before change in DL/UL configuration, in accordance with change in DL/UL configuration;

FIG. 13 provides diagrams for explaining an example of the feedback method of a transmission acknowledgement signal of each DL subframe before and after change in DL/UL configuration, in accordance with change in DL/UL configuration;

FIG. 14 is a diagram schematically illustrating an example of a radio communication system according to the present embodiment;

FIG. 15 is a diagram for explaining the entire configuration of a radio base station according to the present embodiment;

FIG. 16 is a diagram for explaining the functional structures of the radio base station according to the present embodiment;

FIG. 17 is a diagram for explaining the entire configuration of a user terminal according to the present embodiment; and

FIG. 18 is a diagram for explaining the functional structures of the user terminal according to the present embodiment.

### DESCRIPTION OF EMBODIMENTS

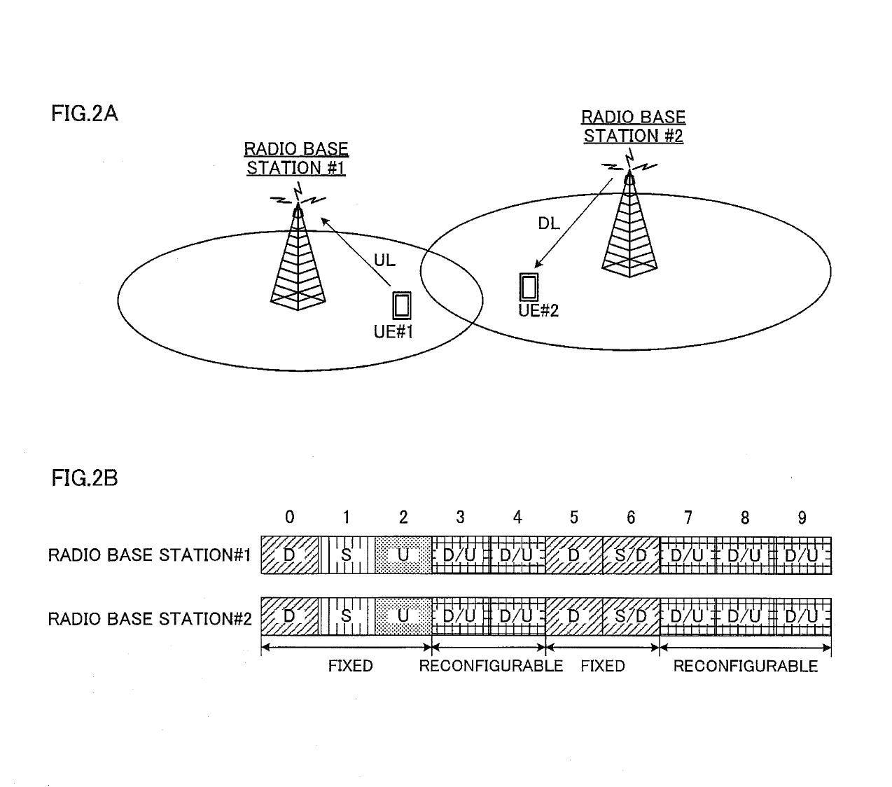

First description is made, with reference to FIG. 2A, about an example of a radio communication system to which a present embodiment is applied. The radio communication system illustrated in FIG. 2A is configured to include a plurality of transmission/reception points (here, radio base stations #1 and #2) and user terminals #1, #2 communicating with the radio base stations #1 and #2, respectively.

In FIG. 2A, radio communication between the radio base station #1 and the user terminal #1 and radio communication between the radio base station #2 and the user terminal #2 are performed by time division duplex (TDD). That is, the radio base stations #1 and #2 use the same frequency domain for DL and UL transmission and divide it into DL and UL by time domain for transmission.

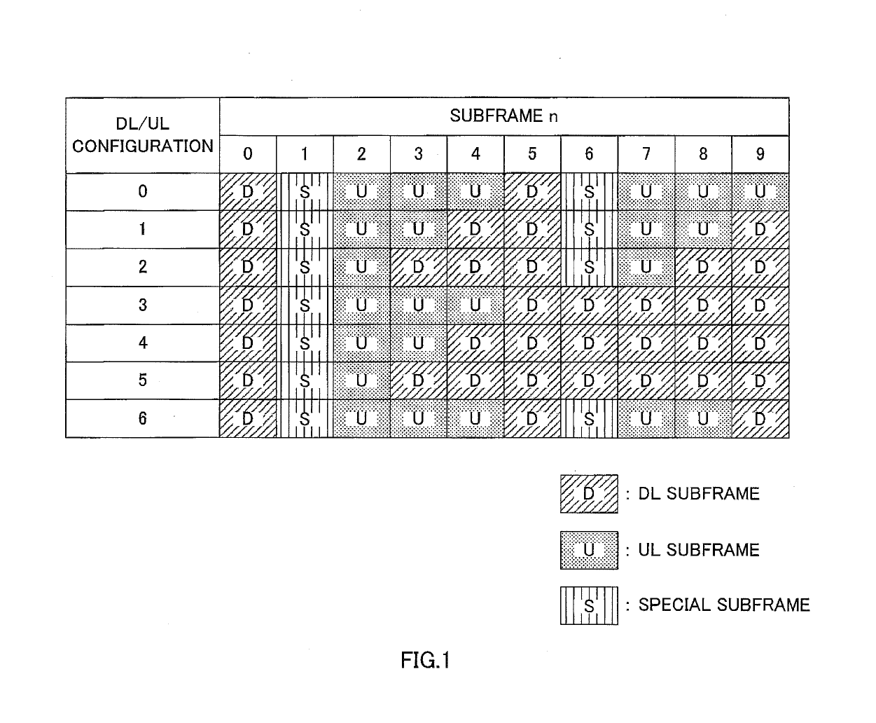

As described above, in LTE-A (Rel. 12 or later), there has been considered a communication scheme in which each of the radio base stations #1 and #2 controls to change the DL/UL configuration dynamically (Flexible TDD DL/UL time configuration scenario). For example, each radio base station is expected to change the DL/UL configuration (DL/UL configurations 0 to 6 in FIG. 1) defined in LTE Rel. 10 in accordance with traffic, the number of user terminals and so on. In addition, it is also expected to control the DL/UL configuration applied to each radio base station in consideration of interference between radio base stations (interference coordination).

In this case, while the subframes 0, 1, 2, 5 and 6 are unchanged over the DL/UL configurations 0 to 6, the subframes 3, 4, 7, 8 and 9 are changed in transmission direction. Accordingly, the subframes 0, 1, 2, 5 and 6 can be defined as fixed subframes and subframes 3, 4, 7, 8 and 9 can be defined as flexible subframes or dynamic subframes (see FIG. 2B). Here, the subframe type is defined assuming that special subframes are DL subframes.

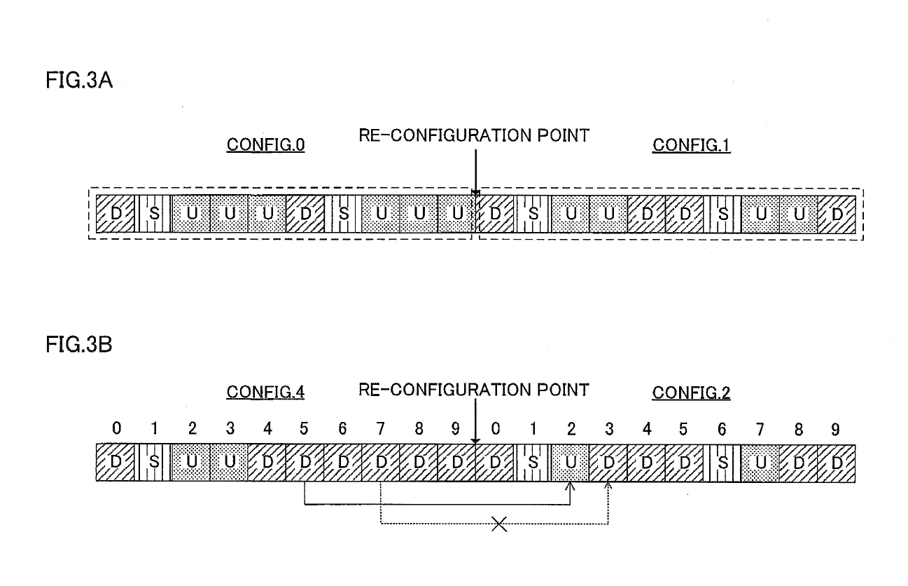

For example, each of the radio base stations #1 and #2 is able to change the DL/UL configuration 1 to the DL/UL configuration 1, as illustrated in FIG. 3A (reconfiguration). By changing the DL/UL configuration appropriately in accordance with a communication environment, it is possible to control the communication system flexibly to improve the throughputs. For example, if the amount of data transmitted from the user terminal to the radio base station is large, the DL/UL configuration with more UL subframes is selected. On the other hand, if the amount of data transmitted from the radio base station to the user terminal is large (for example, when the user terminal downloads movie data), the DL/UL configuration with more DL subframes is considered to be selected.

Then, in TDD of Rel. 10 or later, when receiving a downlink signal in a DL subframe, a user terminal feeds back an uplink control signal in response to the downlink signal in a UL subframe. For example, the user terminal feeds back, in a UL subframe, a transmission acknowledgement signal (HARQ feedback) in response to a PDSCH signal received in a DL subframe. In this case, a transmission acknowledgement signal corresponding to each DL subframe is defined to be fed back using a predetermined UL subframe. That is, each DL subframe is associated with a specific UL subframe to use for feedback.

In addition, as a UL subframe corresponding to each DL subframe, there is defined a UL subframe that is at least a predetermined period (four subframes) after the DL subframe. Therefore, where there is change in DL/UL configuration, such change may be performed between reception of the downlink signal by the user terminal and feedback of an uplink control signal (PUCCH signal) by the user terminal. That is, there may be a case where a DL subframe and a UL subframe to use in feedback of a transmission acknowledgement signal of a PDSCH signal transmitted in the DL subframe are configured with different DL/UL configurations.

For example, as illustrated in FIG. 3B, it is assumed that the DL/UL configuration 4 is changed to the DL/UL configuration 2. If the DL/UL configuration is not changed, a transmission acknowledgement signal in response to the PDSCH signal to be transmitted in the DL subframe 5 of the DL/UL configuration 4 is fed back in the UL subframe 2 of the next frame. In addition, a transmission acknowledgement signal in response to each PDSCH signal to be transmitted in the DL subframe 7 of the DL/UL configuration 4 is fed back in the UL subframe 3 of the next frame.

However, in the changed DL/UL configuration 2, the third subframe is DL subframe. That is, in accordance with change in DL/UL configuration, the transmission direction of the third subframe is changed from UL to DL. Consequently, the user terminal is not able to feed back a transmission acknowledgement signal corresponding to the DL subframe 7 of the DL/UL configuration 4. Thus, in the case where the DL/UL configuration is controlled to be changed, if the mechanism of feedback timing of transmission acknowledgement signals in Rel. 10 is applied as it is, there may occur a problem in feedback of the transmission acknowledgement signals.

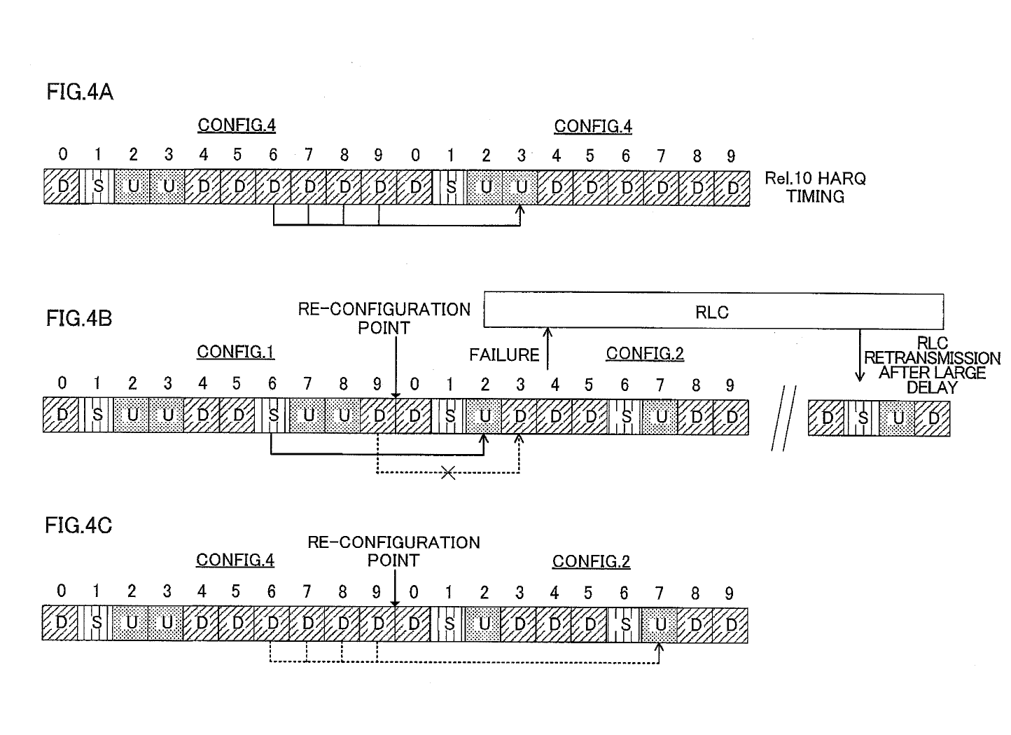

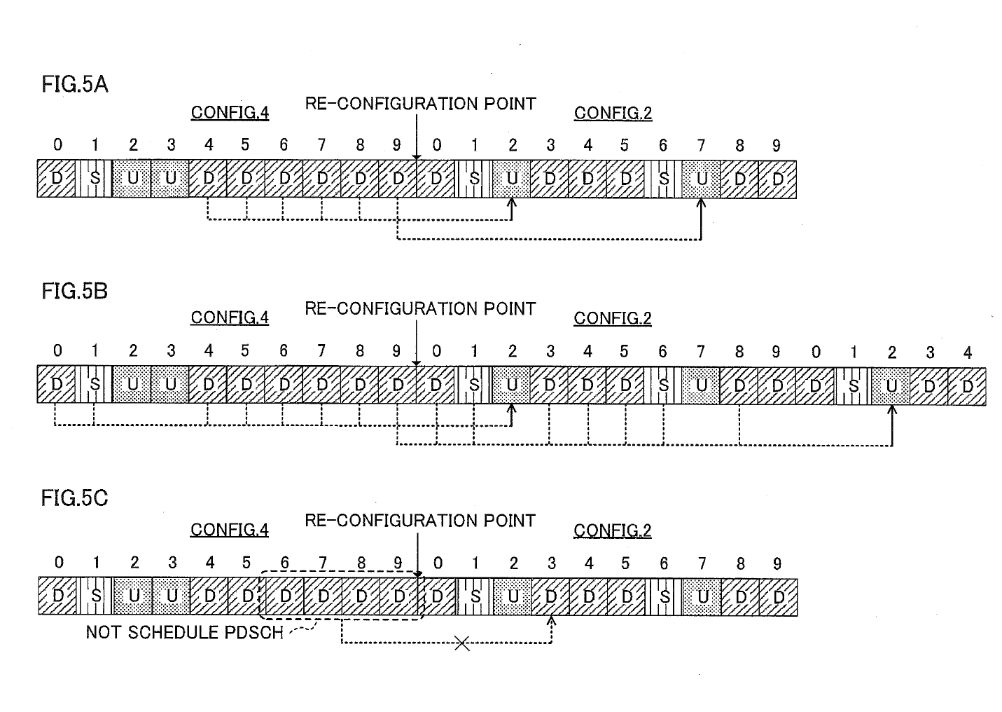

Then, study has been made about the method of controlling an UL subframe to use in feedback of a transmission acknowledgement signal in response to each DL subframe when the DL/UL configuration is changed. The following description is made about the control method used when DL subframes and UL subframes corresponding to the DL subframes are configured over different DL/UL configurations, with reference to FIGS. 4 and 5.

FIG. 4A illustrates the case where the DL/UL configuration 4 is not changed, FIG. 4B illustrates the case where the DL/UL configuration is changed from 1 to 2 and FIG. 4C illustrates the case where the DL/UL configuration is changed from 4 to 2. In FIG. 4A, the feedback method of a transmission acknowledgement signal per DL subframe applied is the same method as that in Rel. 10. For example, transmission acknowledgement signals in response to PDSCH signals of DL subframes 6, 7, 8 and 9 are fed back in the UL subframe 3 of the next frame.

On the other hand, in FIG. 4B, by change in DL/UL configuration, the transmission direction of the subframe 3 (UL subframe) in the previous radio frame (radio frame before change in DL/UL configuration) is changed to DL subframe in the following radio frame (radio frame after change in DL/UL configuration). Thus, if the transmission direction of a subframe to use in feedback of a transmission acknowledgement signal is changed from UL to DL with change in DL/UL configuration, the following processing is considered to be performed.

For example, as illustrated in FIG. 4B, a transmission acknowledgement signal of the DL subframe 9 before change in DL/UL configuration (DL/UL configuration 1) is not able to be fed back in the subframe 3 after change in DL/UL configuration (DL/UL configuration 2). Thus, if a transmission acknowledgement signal cannot be transmitted in response to a PDSCH signal transmitted on the subframe 9 of the DL/UL configuration 1 and a predetermined number of retransmissions by HARQ are failed finally, retransmission control is performed in an RLC layer as higher protocol layer. If the DL/UL configuration is changed from 4 to 2, transmission acknowledgement signals of the DL subframes 6, 7, 8 and 9 before change in DL/UL configuration cannot be transmitted. Therefore, if a predetermined number of retransmissions are failed finally in the like manner, retransmission control is performed in the RLC layer as a higher protocol layer.

Or as illustrated in FIG. 4C, transmission acknowledgement signals in response to the PDSCH signals to be transmitted in subframes 6, 7, 8 and 9 of the DL/UL configuration 4 are considered to be fed back using a UL subframe that is after the subframe 3 of the DL/UL configuration 2 but is closest to the subframe 3 of the DL/UL configuration 2 (here, the UL subframe 7).

Or, as illustrated in FIG. 5A, it can be considered that irrespective of change in DL/UL configuration, a transmission acknowledgement signal in response to a DL subframe is fed back using a UL subframe that is 4 or more subframes after the DL subframe but is closest to the DL subframe. In addition, it is also considered that a transmission acknowledgement signal in response to each DL subframe is fed back using a predetermined UL subframe (fixed subframe or UL subframe that is not changed from the previous radio frame to the following radio frame) (see FIG. 5B).

Besides, when the transmission direction of a subframe to feed back a transmission acknowledgement signal is changed from DL to UL in accordance with change in DL/UL configuration, allocation of downlink signals may be controlled using a scheduler provided at the radio base station side. For example, allocation of a PDSCH signal is not made to a DL subframe of which a corresponding subframe to use in feedback of a transmission acknowledgement signal has a transmission direction of DL (see FIG. 5C). That is, if a DL subframe is to be fed back using a subframe of which the transmission direction is changed from UL to DL in the radio frame after change in DL/UL configuration, the radio base station does not schedule any PDSCH to such a DL subframe.

However, in the method illustrated in FIG. 5C, there occurs a DL subframe with no PDSCH scheduled, which may cause reduction in DL throughput (reduction of use efficiency of radio resources). On the other hand, in the methods illustrated in FIGS. 4B, 4C and 5B, there may occur a large delay in feedback of transmission acknowledgement signals and so on. Further, in the methods illustrated in FIGS. 5A and 5B, the amount of feedback in one UL subframe (ACK/NACK feedback load) may be increased problematically.

Thus, if there occurs delay in retransmission depending on higher layers (RLC retransmission), delay in feedback of transmission acknowledgement signals and unbalanced feedback amount, the system performance may deteriorate. In order to prevent such a situation, if a transmission acknowledgement signal of the DL subframe of the previous DL/UL configuration (before change in DL/UL configuration) is fed back in a UL subframe of the changed DL/UL configuration, it is preferable to reduce feedback delay of the transmission acknowledgement signals (short feedback latency). Further, the feedback amount is expected to be dispersed between UL subframes (balanced feedback load).

Then, the present inventors have found the idea of reconfiguring a UL subframe to use in feedback of a transmission acknowledgement signal of a DL subframe before change in DL/UL configuration, in consideration of the feedback range covered by the UL subframe after change in DL/UL configuration. The present inventors have also found that out of DL subframes in a radio frame before change in DL/UL configuration, if a DL subframe can be fed back using a UL subframe in the same radio frame, such a DL subframe is controlled to be fed back with the transmission timing before change in DL/UL configuration.

Specifically, the first step is to determine the feedback timing of a transmission acknowledgement signal of each DL subframe in a radio frame before change in DL/UL configuration. The next step is to control (reconfigure) a UL subframe to use in feedback of a transmission acknowledgement signal of each DL subframe based on the feedback timing of the transmission acknowledgement signal. Then, as to a transmission acknowledgement signal to feed back in the radio frame after change in DL/UL configuration, a UL subframe to use in feedback is reconfigured based on the feedback range (feedback window) covered by the UL subframe after change in DL/UL configuration. Besides, as to a transmission acknowledgement signal to feed back in the radio frame before change in DL/UL configuration, the feedback timing of the radio frame before change in DL/UL configuration is still used.

With this structure, even if the DL/UL configuration is changed, it is possible to allocate a transmission acknowledgement signal of a DL subframe in a radio frame just before change in DL/UL configuration to an appropriate UL subframe in a radio frame after change in DL/UL configuration. Consequently, it is possible to reduce delay in feedback of a transmission acknowledgement signal of a DL subframe before change in DL/UL configuration and also possible to allocate transmission acknowledgement signals to feed back to UL subframes after change in DL/UL configuration in a distributed manner.

With reference to the accompanying drawings, the present embodiment is described in detail below. In the following description, some of the configurations defined in LTE Rel. 10 (see FIG. 1) are taken as an example of the DL/UL configuration, however, the DL/UL configuration applicable to the present embodiment is not limited to them. The DL/UL configurations applicable to the present embodiment are also not limited to those defined in LTE Rel. 10.

### <DL Subframe Classification>

A radio base station (transmission/reception point) determines the type of each DL subframe based on the feedback timing of a transmission acknowledgement signal in a radio frame before change in DL/UL configuration (previous radio frame).

In the present embodiment, DL subframes in the previous radio frame are classified into two types. This determination of DL subframe classification can be made based on existing HARQ schedule (LTE Rel. 10). In the following description, transmission acknowledgement signals (HARQ feedback) are illustrated as feedback signals corresponding to the respective DL subframes, which is however not intended to limit the present invention.

A DL subframe of first type (Type 1) represents a DL subframe of which a transmission acknowledgement signal is allowed to be fed back using an UL subframe in the same radio frame (Case A). A transmission acknowledgement signal of the first-type DL subframe can be fed back with the feedback timing of HARQ applied to each previous radio frame (radio frame before change in DL/UL configuration).

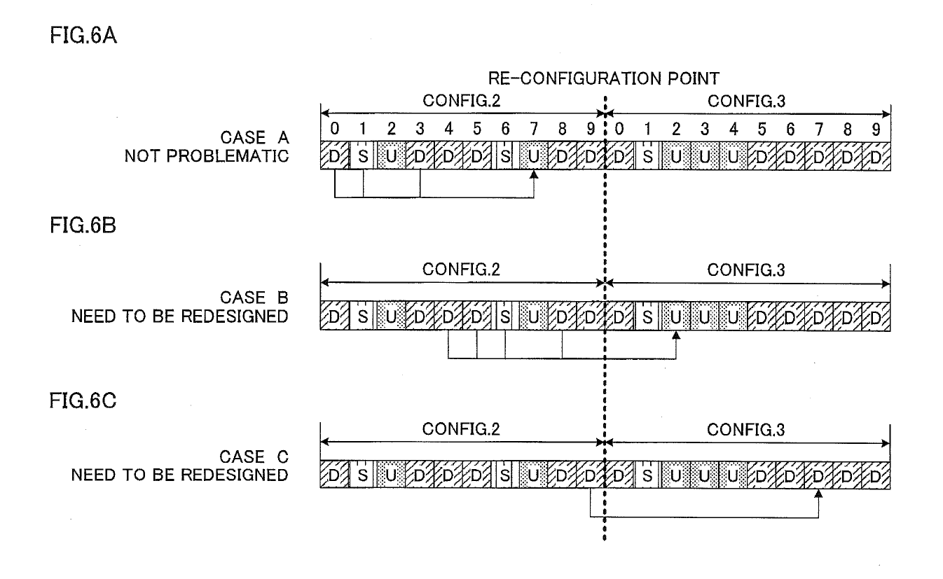

For example, as illustrated in FIG. 6A, the DL/UL configuration is assumed to be changed from 2 to 3. In this case, transmission acknowledgement signals corresponding to DL subframes 0, 1, 3 in a previous radio frame are fed back using the UL subframe 7 of the same radio frame. Therefore, DL subframes 0, 1, 3 of the radio frame before change in DL/UL configuration are of Type 1 (Case A). In this case, as for DL subframes 0, 1, 3, the feedback timing defined in the DL/UL configuration 2 (for example, LTE Rel. 10) is maintained.

A DL subframe of second type (Type 2) represents a DL subframe of which a transmission acknowledgement signal is allowed to be fed back using a UL subframe of a following radio frame (radio frame after change in DL/UL configuration) (see FIGS. 6B, 6C). That is, in Type 2, the DL subframe and the UL subframe to use in feedback of a transmission acknowledgement signal of the DL subframe are configured in different DL/UL configurations.

Further, Type 2 can be further classified into two cases. The first case (Case B) is such that a subframe to use in feedback of a transmission acknowledgement signal is a UL subframe in the following radio frame (see FIG. 6B). That is, in this case, even when there is change in the DL/UL configuration, the transmission direction of a subframe to use in feedback of a transmission acknowledgement signal is not changed.

For example, when the DL/UL configuration 2 is applied, transmission acknowledgement signals of DL subframes 4, 5, 6, 8 are fed back in UL subframe 2 of the following frame. On the other hand, in the DL/UL configuration 3, the subframe 2 is a UL subframe. Therefore, as illustrated in FIG. 6B, even when the DL/UL configuration 2 is changed to the DL/UL configuration 3, the transmission direction of the subframe 2 remains unchanged as uplink. Consequently, the DL subframes 4, 5, 6, 8 of the previous radio frame are determined to be of Type 2 (Case B).

The second case of Type 2 (Case C) is such that a subframe to use in feedback of a transmission acknowledgement signal becomes a DL subframe in the following radio frame (see FIG. 6C). That is, in this case, the transmission direction of a subframe to use in feedback of a transmission acknowledgement signal is changed (from UL to DL).

For example, when the DL/UL configuration 2 is applied, a transmission acknowledgement signal of the DL subframe 9 is fed back in the UL subframe 7 of the following radio frame. However, in the DL/UL configuration 3, the subframe 7 becomes a DL subframe. Therefore, as illustrated in FIG. 6C, when the DL/UL configuration is changed from 2 to 3, the transmission direction of the subframe 7 is changed from UL to DL. Consequently, the DL subframe 9 of the previous radio frame is determined to be of Type 2 (Case C).

In the present embodiment, a UL subframe to use in feedback of a transmission acknowledgement signal of a DL subframe of Type 2 (Case B, C) mentioned above is re-selected based on the feedback range covered by a UL subframe of the following radio frame (feedback window). Here, the feedback range covered by a UL subframe of the following radio frame (corresponding to a UL subframe after change in DL/UL configuration) can be determined based on the feedback timing of HARQ applied to each following radio frame after change in DL/UL configuration as described later.

Thus, by controlling the HARQ feedback timing in accordance with the type of a DL subframe of a previous radio frame before change in DL/UL configuration, it is possible to make full use of the existing (LTE Rel. 10) mechanism in a radio frame before and after change in DL/UL configuration. In addition, by controlling the HARQ feedback timing in consideration of the feedback range covered by each UL subframe of the following radio frame, it is possible to perform HARQ feedback appropriately even in the case of above-mentioned second type (Type 2). Consequently, it is possible to reduce delay in feedback of transmission acknowledgement signals and also possible to disperse the feedback amount of transmission acknowledgement signals to UL subframes in a radio frame after change in DL/UL configuration.

### <Configuration of Feedback Range>

Next description is made about the feedback range (feedback window) applied to transmission acknowledgement signals of DL subframes of Type 2 mentioned above.

The feedback range covered by a UL subframe (feedback window) indicates the range of subframes of which transmission acknowledgement signals are to be fed back using this UL subframe. That is, the subframe range is a range of subframes of which the UL subframe can feed back transmission acknowledgement signals. The feedback range corresponding to each UL subframe can be determined based on the HARQ feedback timing of LTE Rel. 10.

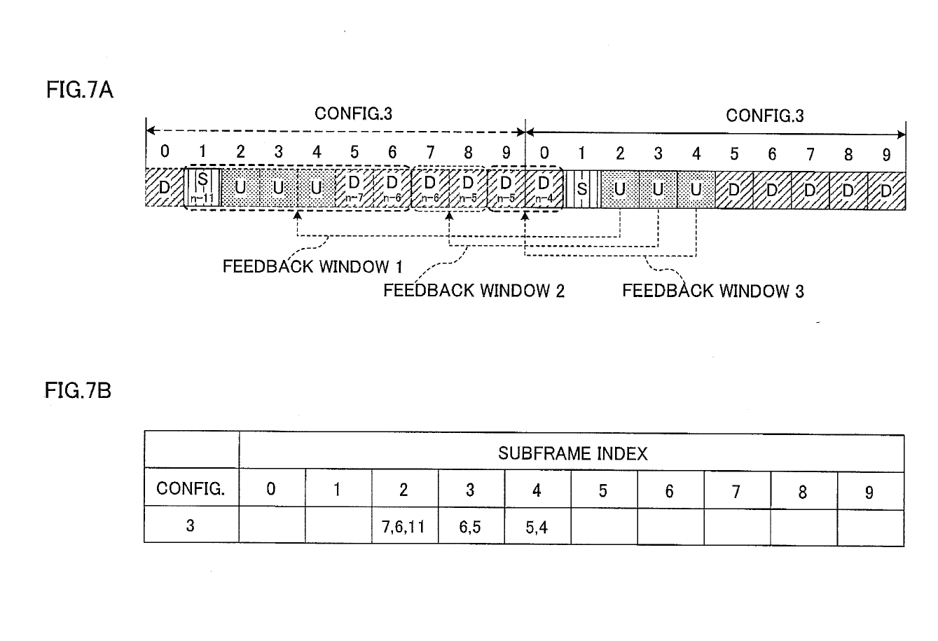

FIG. 7A illustrates an example of the method for configuring the feedback range according to the present embodiment. In FIG. 7A, the DL/UL configuration 3 is taken as an example, however, any other DL/UL configuration may be used to configure the feedback range. In addition, in the example of FIG. 7A, two frames of the DL/UL configuration 3 are illustrated consecutively. However, the feedback range may be configured in the same manner even when the DL/UL configuration is changed.

In FIG. 7A, the feedback ranges 1, 2, 3 corresponding to UL subframes 2, 3, 4 in the latter radio frame are illustrated. The starting point of each feedback range (the first subframe) is the first DL subframe covered by each UL subframe. Here, the first DL subframe used here means the earliest DL subframe (or S subframe) in the time domain.

In FIG. 7A, the first DL subframe corresponding to the UL subframe 2 in the latter radio frame is the subframe 1 in the former radio frame (S subframe). Likewise, the first DL subframe corresponding to the UL subframe 3 in the latter radio frame is the subframe 7 in the former radio frame (DL subframe). The first DL subframe corresponding to the UL subframe 4 in the latter radio frame is the subframe 9 in the former radio frame (DL subframe).

The first DL subframe corresponding to each UL subframe can be determined based on the HARQ timing of LTE Rel. 10. For example, it can be determined using the timing table illustrated in FIG. 7B. The timing table in FIG. 7B corresponds to the timing table of the DL/UL configuration 3, defining that a UL subframe 2 is used to feed back transmission acknowledgement signals of DL subframes that are 7-subframe, 6-subframe and 11-subframe before the UL subframe 2. Likewise, the UL subframe 3 is used to feed back transmission acknowledgement signals of DL subframes that are 6-subframe and 5-subframe before the UL subframe 3, and the UL subframe 4 is used to feed back transmission acknowledgement signals of DL subframes that are 5-subframe and 4-subframe before the UL subframe 4.

In addition, the end point of each feedback range (last subframe) can be configured to be a subframe just before the first DL subframe of the feedback range corresponding to another UL subframe that is configured next in the time domain. Therefore, the feedback range corresponding to a certain UL subframe starts at the first DL subframe corresponding to the UL subframe and ends at the subframe just before the starting subframe of the feedback range of anther UL subframe. That is, the feedback ranges of respective UL subframes are configured not to overlap each other.

In FIG. 7A, the feedback range of the UL subframe 2 in the latter frame (feedback window 1) ranges from subframe 1 to subframe 6 in the former frame. The feedback range of the UL subframe 3 in the latter frame (feedback window 2) ranges from subframe 7 to subframe 8 in the former frame. The feedback range of the UL subframe 4 in the latter frame (feedback window 1) ranges from subframe 9 in the former frame to subframe 0 in the latter frame. The number of configured feedback ranges is the number of UL subframes to use in transmission of a transmission acknowledgement signals in the radio frame after change in DL/UL configuration.

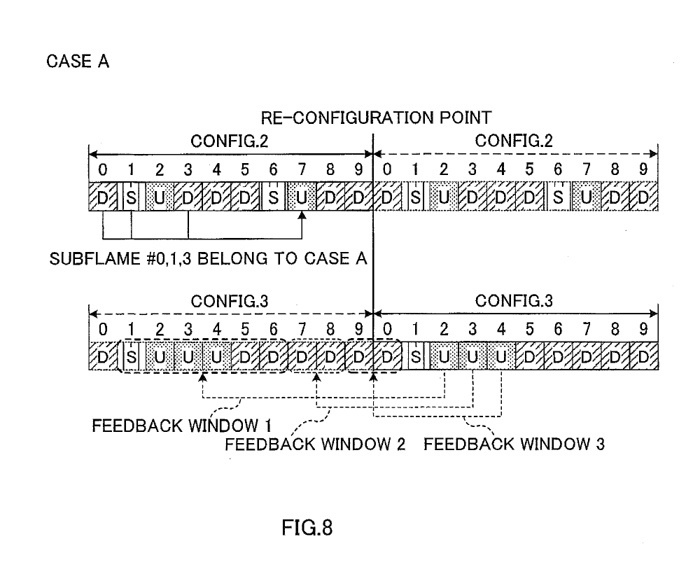

Next description is made, with reference to FIGS. 8 to 10 about the case of, when the DL/UL configuration is changed, reconfiguring a UL subframe to use in feedback of transmission acknowledgement signals of DL subframes based on the above-mentioned feedback range. FIGS. 8 to 10 each illustrate an example of the case where the DL/UL configuration is changed from 2 to 3 (solid line in FIGS. 8 to 10). In FIGS. 8 to 10, for convenience of explanation, each of the DL/UL configurations 2 and 3 is applied to two consecutive frames.

First, the radio base station (transmission/reception point) determines the type of each DL subframe based on the timing of feeding back a transmission acknowledgement signal of the DL subframe in a radio frame before change in DL/UL configuration. Specifically, it is determined which type each DL subframe of the previous radio frame before change in DL/UL configuration is, between Type 1 and Type 2. Then, a UL subframe to use in feedback of a transmission acknowledgement signal of each DL subframe is determined based on the type of the DL subframe.

Regarding DL subframes 0, 1, 3 in the radio frame before change in DL/UL configuration, their transmission acknowledgement signals can be fed back using the subframe 7 in the same radio frame. Therefore, the DL subframes 0, 1 and 3 belong to Type 1 (Case A) in FIG. 6 mentioned above. Accordingly, the radio base station controls the user terminal to use the UL subframe 7 in feedback of the DL subframes 0, 1, 3 in the radio frame before change in DL/UL configuration (see FIG. 8). That is, transmission acknowledgement signals of the DL subframes 0, 1 and 3 are applied with HARQ feedback timing in the DL/UL configuration 2.

On the other hand, in the radio frame before change in DL/UL configuration, transmission acknowledgement signals of other DL subframes 4, 5, 6, 8 and 9 than the DL subframes 0, 1 and 3 are fed back in the radio frame after change in DL/UL configuration. Therefore, the DL subframes 4, 5, 6, 8 and 9 of the radio frame before change in DL/UL configuration belong to Type 2. Regarding transmission acknowledgement signals of the DL subframes of Type 2, a UL to use in feedback is determined based on the above-mentioned feedback range (feedback window).

Here, among the DL subframes of Type 2, if a DL subframe is not covered by any feedback range, a transmission acknowledgement signal of such a DL subframe can be sent with the existing HARQ transmission timing (LTE Rel. 10). In the following description, Case B and Case C of Type 2 are dealt with specifically.

The transmission acknowledgement signals of the DL subframes 4, 5, 6 and 8 in the radio frame before change in DL/UL configuration can be fed back using the UL subframe 2 in the radio frame after change in DL/UL configuration. Therefore, the DL subframes 4, 5, 6 and 8 belong to Type 2 (Case B) in FIG. 6 mentioned above.

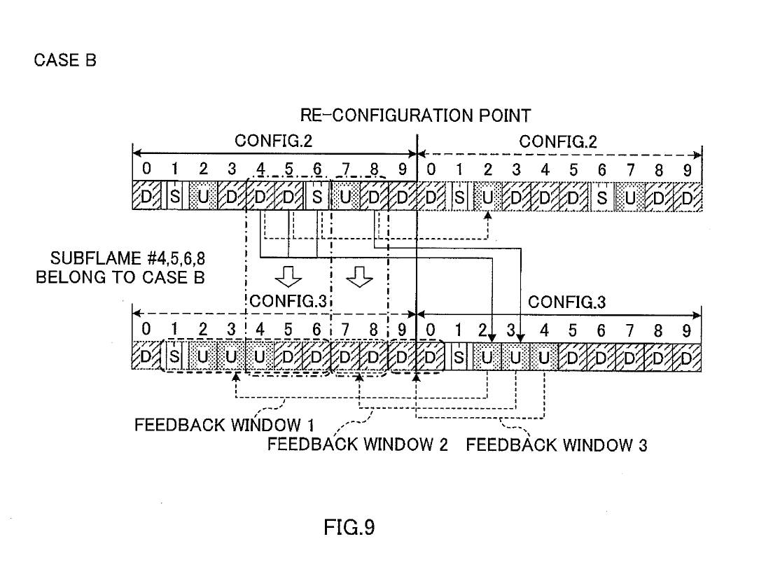

The radio base station determines the feedback range corresponding to each of the DL subframes 4, 5, 6 and 8 by comparing the DL subframes 4, 5, 6, 8 and the feedback ranges configured by UL subframes after change in DL/UL configuration. Then, the radio base station uses a UL subframe corresponding to the feedback range to feed back a transmission acknowledgement signal of a corresponding DL subframe. In FIG. 9, transmission acknowledgement signals of the DL subframes 4, 5, 6 in the radio frame before change in DL/UL configuration are fed back using the UL subframe 2 corresponding to the feedback range 1. A transmission acknowledgement signal of the DL subframe 8 is fed back using the UL subframe 3 corresponding to the feedback range 2.

In the case illustrated in FIG. 9, if the existing HARQ timing is applied as it is, feedback signals of the DL subframes 4, 5, 6 and 8 are fed back using the UL subframe 2. However, according to the present embodiment, the feedback signal of the DL subframe 8 can be transmitted using the UL subframe 3 that is newly defined by change in DL/UL configuration. With this structure, it is possible to disperse the feedback amount per UL subframe.

Here, if regarding a DL subframe belonging to Type 2 (Case B), a corresponding feedback range is not configured, its transmission acknowledgement signal is to be fed back with the existing (LTE Re. 10) HARQ timing.

On the other hand, a transmission acknowledgement signal of the DL subframe 9 in the radio frame before change in DL/UL configuration cannot be fed back using the subframe 7 in the radio frame after change in DL/UL configuration. Therefore, the DL subframe belongs to Type 2 (Case C) in FIG. 6 mentioned above.

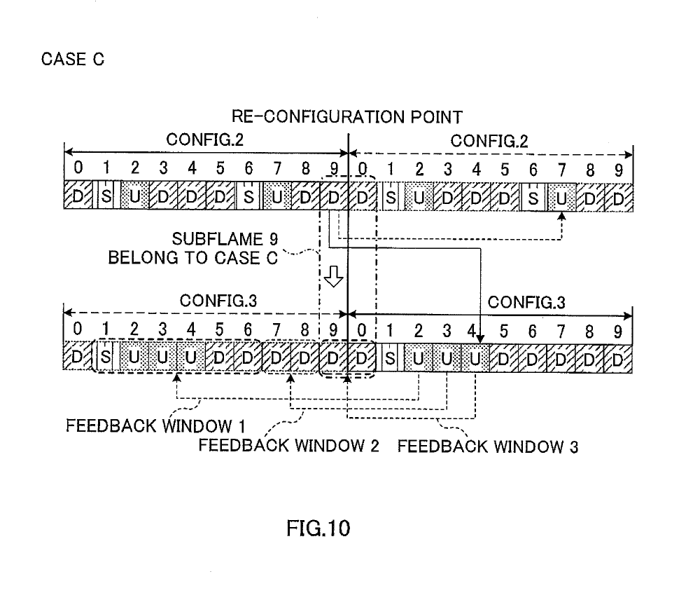

The radio base station determines the feedback range corresponding to the DL subframe 9 by comparing the DL subframe 9 and the feedback range configured by each UL subframe after change in DL/UL configuration. Then, a transmission acknowledgement signal of the DL subframe is fed back using the UL subframe corresponding to the feedback range. In FIG. 10, a feedback signal of the DL subframe 9 in the radio frame before change in DL/UL configuration is fed back using the UL subframe 4 corresponding to the feedback range 3.

Thus, as the UL subframe to use in feedback of a transmission acknowledgement signal of a DL subframe before change is determined based on the feedback window covered by the UL subframe after change in DL/UL configuration, it is possible to suppress feedback delay. Further, as transmission acknowledgement signals allocated to one UL subframe can be dispersed to a plurality of UL subframes after change in DL/UL configuration, it is possible to balance the feedback amount between UL subframes.

When the feedback timing of a transmission acknowledgement signal is changed by change in DL/UL configuration as mentioned above, the radio base station notifies the user terminal of new feedback timing (HARQ timing). In accordance with change in DL/UL configuration, it is possible to introduce a new timing table defining new feedback timing of transmission acknowledgement signals.

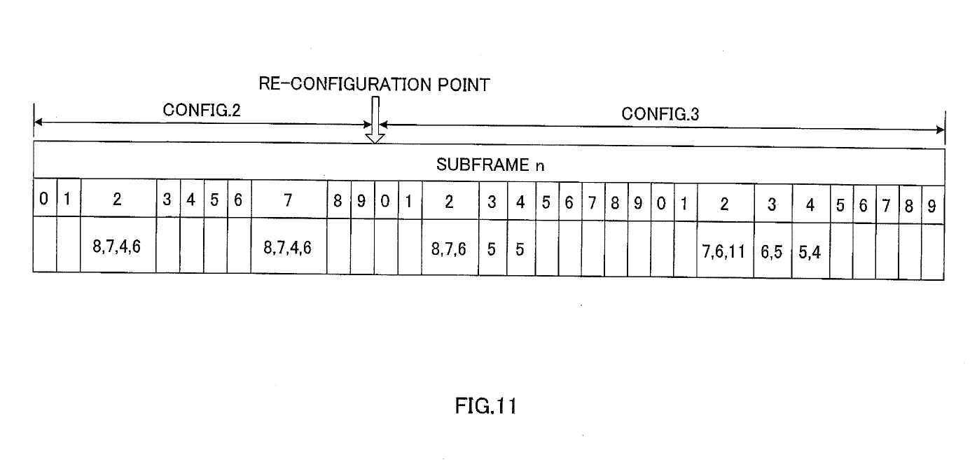

For example, the timing table as illustrated in FIG. 11 can be introduced. FIG. 11 illustrates an example of timing table in which DL subframes corresponding to each UL subframe are defined in the case of change from the DL/UL configuration 2 to the DL/UL configuration 3. In FIG. 11, the timing table of three consecutive frames is illustrated, in which the first frame is configured with the DL/UL configuration 2, and the second and third frames are configured with the DL/UL configuration 3.

In the first frame, the UL subframe 2 corresponds to DL subframes that are 8, 7, 4, 6-subframe before the UL subframe 2. In other words, the UL subframe 2 is used to feed back transmission acknowledgement signals of the DL subframes 8, 7, 4 and 6-subframe before the UL subframe. Likewise, the UL subframe 7 corresponds to DL subframes that are 8, 7, 4, 6-subframe before the UL subframe 7. This is the same as HARQ scheduling of LTE Rel. 10.

Further, in the third frame, the UL subframe 2 corresponds to DL subframes that are 7, 6, 11-subframe before the UL subframe 2. That is, the UL subframe 2 is used to feed back transmission acknowledgement signals of the DL subframes that are 7, 6, 11-subframe before the UL subframe 2. Likewise, the UL subframe 3 corresponds to DL subframes that are 6, 5-subframe before the UL subframe 3 and the UL subframe 4 corresponds to DL subframes that are 5, 4-subframe before the UL subframe 4. This is the same as HARQ scheduling of LTE Rel. 10.

On the other hand, the second frame is a radio frame after change in DL/UL configuration. Therefore, this frame is defined different from HARQ scheduling of LTE Rel. 10. As described above, DL subframes corresponding to a feedback range covered by each UL subframe after change in DL/UL configuration are defined. In this case, the UL subframe 2 corresponds to DL subframes that are 8, 7, 6-subframe before the UL subframe 2, and the UL subframe 3 corresponds to DL subframe that is 5-subframe before the UL subframe 3 (see FIG. 9 above). Likewise, the UL subframe 4 corresponds to a DL subframe that is 5-subframe before the UL subframe 4 (see FIG. 10 above).

### <Operation in Change in DL/UL Configuration>

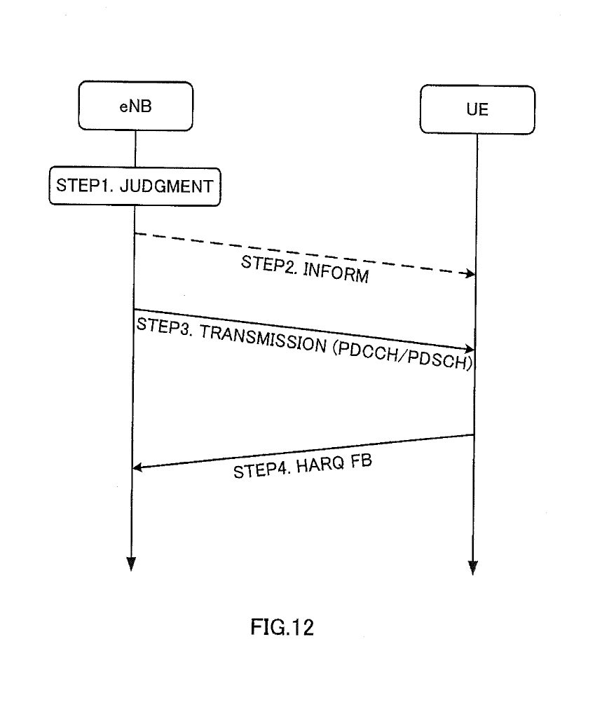

Next description is made, with reference to the sequence diagram of FIG. 12, about an example of the operation in change of the DL/UL configuration. Here, the DL/UL configuration 2 is assumed to be changed to the DL/UL configuration 3 (see FIGS. 8 to 10).

First, the radio base station determines the type of each DL subframe in a radio frame before change in DL/UL configuration (DL/UL configuration 2). For example, it is determined to which each DL subframe belongs to, Type 1 or Type 2 (preferably, Case A to Case C) (see FIG. 6 above). Then, in accordance with the type of each DL subframe, a UL subframe to use in feedback of a transmission acknowledgement signal of the DL subframe is controlled (Step 1). Specifically, with reference to FIGS. 8 to 10 above, the UL subframe to use in feedback of a transmission acknowledgement signal of each DL subframe is reconfigured in accordance with Type.

Next, the radio base station notifies the user terminal of information (redesigned HARQ timeline) about the feedback timing of a transmission acknowledgement signal that is newly defined by change in DL/UL configuration (Step 2). Here, this information may be given implicitly by notification of change in DL/UL configuration. Then, the radio base station transmits, to the user terminal, a downlink signal (PDCCH signal, PDSCH signal and the like) in accordance with the configured DL/UL configuration (Step 3).

The user terminal generates a transmission acknowledgement signal (ACK/NACK) based on a demodulation result of a PDSCH signal received in the DL subframe and feeds back it to the radio base station using an appropriate UL subframe (Step 4). At this time, the user terminal selects a UL subframe to use in feedback of each transmission acknowledgement signal based on information about the feedback timing of the transmission acknowledgement signal given from the radio base station. With this structure, even when the DL/UL configuration is changed, the user terminal is able to feed back a transmission acknowledgement signal without delay and also to feed back transmission acknowledgement signals by dispersing them to a plurality of UL subframes.

Here, according to the present embodiment, when the number of UL subframes in a radio frame after change in DL/UL configuration is greater than the number of UL subframes in a radio frame before change in DL/UL configuration, it is possible to disperse the transmission acknowledgement signals to the plural UL subframes, which brings about more advantageous effects than those in FIG. 5A.

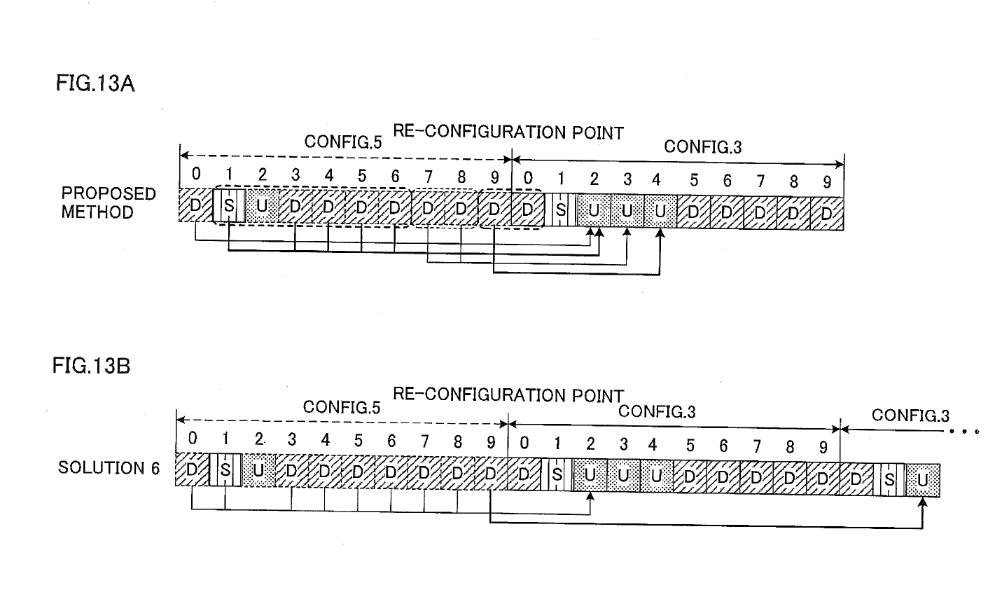

For example, it is assumed that the DL/UL configuration 5 is changed to the DL/UL configuration 3 (see FIG. 13). When the present embodiment is applied, the DL subframes 1, 3 to 9 before change in DL/UL configuration are covered by the feedback ranges 1, 2, 3, corresponding to the UL subframes 2, 3, 4 after change in DL/UL configuration. Therefore, the DL subframes 1, 3 to 9 before change in DL/UL configuration are dispersed and allocated to the UL subframes 2, 3, 4 after change in DL/UL configuration (see FIG. 13A). Here, the DL subframe 0 before change in DL/UL configuration belongs to Type 2 (Case B) mentioned above, however, it is not included in the feedback range and its transmission acknowledgement signal is fed back based on the HARQ timing before change in DL/UL configuration.

On the other hand, FIG. 13B illustrates the case where a transmission acknowledgement signal of each DL subframe is fed back using a UL subframe that is 4 or more-subframe after the DL subframe and is closest to the DL subframe. In this case, transmission acknowledgement signals of the DL subframes 0, 3 to 8 before change in DL/UL configuration are fed back using the UL subframe 2 after change in DL/UL configuration and the feedback amount of the particular UL subframe 2 becomes large.

### <Configuration of Radio Communication System>

The following description is made in detail about a radio communication system according to the present embodiment.

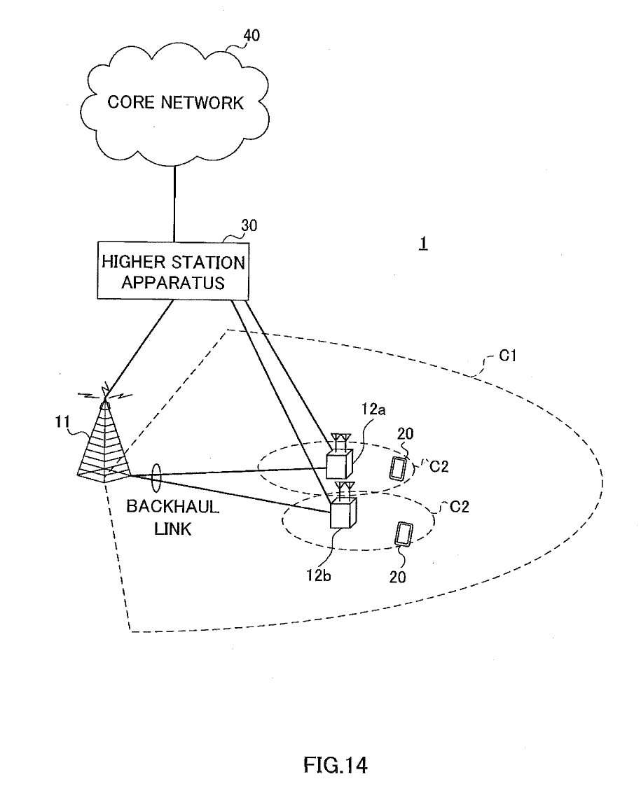

FIG. 14 is a schematic diagram of the radio communication system according to the present embodiment. The radio communication system illustrated in FIG. 14 is an LTE system or a system comprising a SUPER 3G. In this radio communication system, carrier aggregation (CA) can be applied in which a plurality of base frequency blocks (component carriers) are aggregated, each component carrier being a unit of system band of the LTE system. This radio communication system may be called IMT-Advanced, 4G, or FRA (Future Radio Access).

The radio communication system 1 illustrated in FIG. 14 includes a radio base station 11 forming a macro cell C1, and radio base stations 12a and 12b that are arranged within the macro cell C1 and each form a smaller cell C2 than the macro cell C1. In the macro cell C1 and small cells C2, user terminals 20 are located. Each user terminal 20 is able to be connected to both of the radio base station 11 and the radio base stations 12 (dual connectivity). In this case, it is expected that each user terminal 20 uses the macro cell C1 and small cell C2 of different frequency bands simultaneously by CA (Carrier Aggregation).

Communication between the user terminal 20 and the radio base station 11 is performed by using a carrier of a relatively low frequency band (for example, 2 GHz) and a narrow bandwidth (such a carrier is an existing carrier also called “legacy carrier”). On the other hand, the communication between the user terminal 20 and a radio base station 12 may be performed by using a carrier of a relatively high frequency band (for example, 3.5 GHz) and a broad bandwidth or by using the same carrier as communication with the radio base station 11. As the carrier type between the user terminal 20 and the radio base station 12, new carrier type (NCT) may be used. The radio base station 11 and each radio base station 12 (or the radio base stations 12) are connected to each other wiredly (optical fiber, X2 interface or the like) or wirelessly.

The radio base stations 11 and 12 are connected to a higher station apparatus 30, and are also connected to a core network 40 via the higher station apparatus 30. The higher station apparatus 30 includes, but is not limited to, an access gateway apparatus, a radio network controller (RNC), a mobility management entity (MME). Each radio base station 12 may be connected to the higher station apparatus via the radio base station 11.

The radio base station 11 is a radio base station having a relatively wide coverage area and may be called eNodeB, macro base station, transmission/reception point or the like. The radio base station 12 is a radio base station having a local coverage area and may be called small base station, pico base station, femto base station, Home eNodeB, RRH (Remote Radio Head), micro base station, transmission/reception point or the like. In the following description, the radio base stations 11 and 12 are collectively called radio base station 10, unless they are described discriminatingly. Each user terminal 20 is a terminal supporting various communication schemes such as LTE, LTE-A and the like and may comprise not only a mobile communication terminal, but also a fixed or stationary communication terminal.

In the radio communication system, as multi access schemes, OFDMA (Orthogonal Frequency Division Multiple Access) is adopted for the downlink and SC-FDMA (Single Carrier Frequency Division Multiple Access) is adopted for the uplink. OFDMA is a multi-carrier transmission scheme to perform communication by dividing a frequency band into a plurality of narrow frequency bands (subcarriers) and mapping data to each subcarrier. SC-FDMA is a single carrier transmission scheme to perform communications by dividing, per terminal, the system band into bands formed with one or continuous resource blocks, and allowing a plurality of terminals to use mutually different bands thereby to reduce interference between terminals.

Here, description is made about communication channels used in the radio communication system illustrated in FIG. 14. As for downlink communication channels, there are used a PDSCH (Physical Downlink Shared Channel) that is used by each user terminal 20 on a shared basis and downlink L1/L2 control channels (PDCCH, PCFICH, PHICH, enhanced PDCCH). The PDSCH is used to transmit user data and higher control information. The PDCCH (Physical Downlink Control Channel) is used to transmit PDSCH and PUSCH scheduling information and so on. PCFICH (Physical Control Format Indicator Channel) is used to transmit the number of OFDM symbols used in PDCCH. PHICH (Physical Hybrid-ARQ Indicator Channel) is used to transmit HARQ ACK/NACK for PUSCH. Enhanced PDCCH (EPDCCH) may transmit PDSCH and PUSCH scheduling information and so on. This EPDCCH is frequency-division-multiplexed with PDSCH (Downlink Shared Data Channel).

As for the uplink communication channels, there are used a PUSCH (Physical Uplink Shared Channel) that is used by each user terminal 20 on a shared basis and a PUCCH (Physical Uplink Control Channel) as an uplink control channel. The PUSCH is used to transmit user data and higher control information. And, PUCCH is used to transmit downlink radio quality information (CQI: Channel Quality Indicator), transmission acknowledgement signals (ACK/NACK) and so on. Here, in the following description, it is assumed that the radio base station 12 adopts TDD.

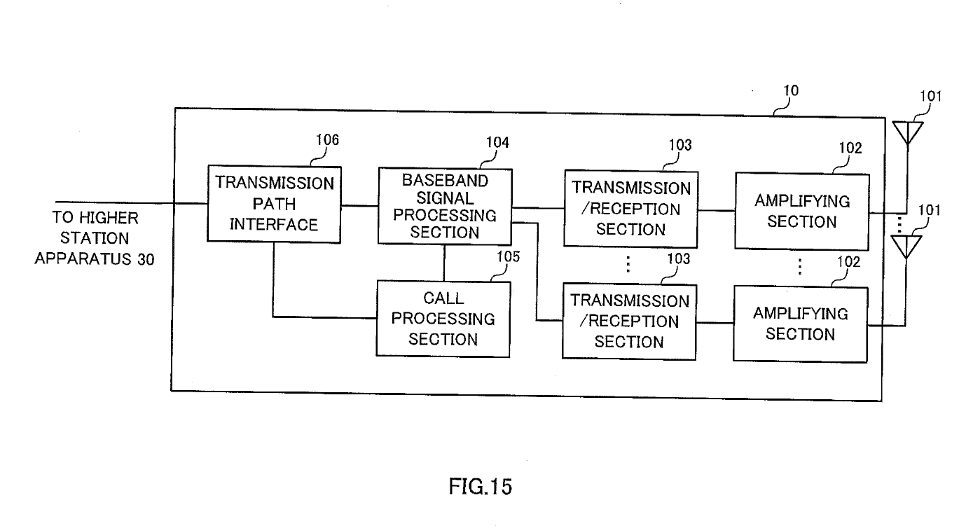

FIG. 15 is a diagram illustrating the entire configuration of the radio base station 10 (including the radio base stations 11 and 12) according to the present embodiment. The radio base station 10 is configured to have a plurality of transmission/reception antennas 101 for MIMO transmission, amplifying sections 102, transmission/reception sections 103, a baseband signal processing section 104, a call processing section 105 and a transmission path interface 106.

User data that is to be transmitted on the downlink from the radio base station 10 to the user terminal 20 is input from the higher station apparatus 30, through the transmission path interface 106, into the baseband signal processing section 104.

In the baseband signal processing section 104, signals are subjected to PDCP layer processing, RLC (Radio Link Control) layer transmission processing such as division and coupling of user data and RLC retransmission control transmission processing, MAC (Medium Access Control) retransmission control, including, for example, HARQ transmission processing, scheduling, transport format selection, channel coding, inverse fast Fourier transform (IFFT) processing, and precoding processing, and resultant signals are transferred to the transmission/reception sections 103. As for signals of the downlink control channel, transmission processing is performed, including channel coding and inverse fast Fourier transform, and resultant signals are also transferred to the transmission/reception sections 103.

Also, the baseband signal processing section 104 notifies each user terminal 20 of control information for communication in the corresponding cell by a broadcast channel. Information for communication in the cell includes, for example, uplink or downlink system bandwidth. Information about TPC described above may be given to the user terminal by using a broadcast channel.

In the transmission/reception sections 103, baseband signals that are precoded per antenna and output from the baseband signal processing section 104 are subjected to frequency conversion processing into a radio frequency band. The frequency-converted radio frequency signals are amplified by the amplifying sections 102 and then, transmitted from the transmission/reception antennas 101.

Meanwhile, as for data to be transmitted on the uplink from the user terminal 20 to the radio base station 10, radio frequency signals are received in the transmission/reception antennas 101, amplified in the amplifying sections 102, subjected to frequency conversion and converted into baseband signals in the transmission/reception sections 103, and are input to the baseband signal processing section 104.

The baseband signal processing section 104 performs FFT processing, IDFT processing, error correction decoding, MAC retransmission control reception processing, and RLC layer and PDCP layer reception processing on the user data included in the baseband signals received on the uplink. Then, the signals are transferred to the higher station apparatus 30 through the transmission path interface 106. The call processing section 105 performs call processing such as setting up and releasing a communication channel, manages the state of the radio base station 10 and manages the radio resources.

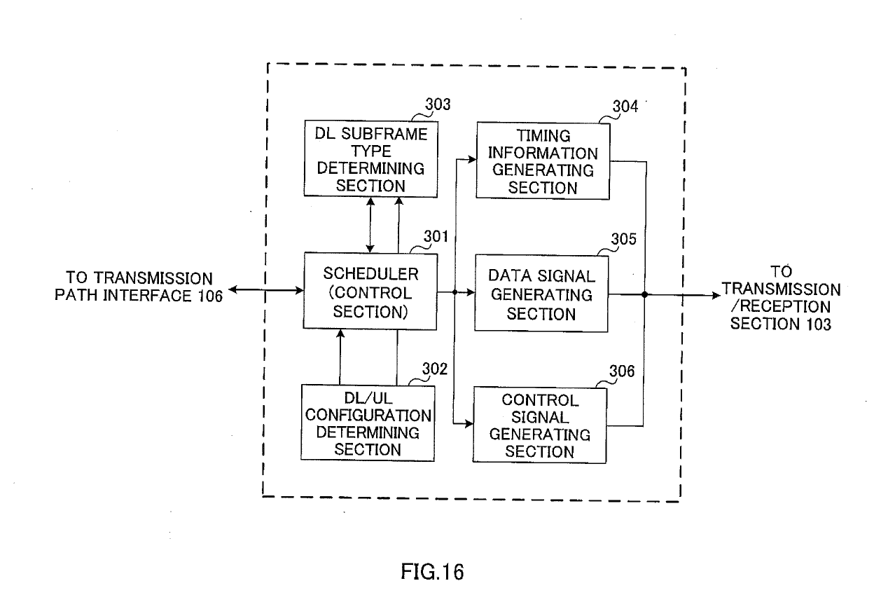

FIG. 16 is a diagram illustrating principal functional structures of the baseband signal processing section 104 provided in the radio base station 10 (e.g., small base station) according to the present embodiment. Although FIG. 16 primarily illustrates downlink (transmission) functional structures, the radio base station 10 may have uplink (reception) functional structures as well.

As illustrated in FIG. 16, the baseband signal processing section 104 of the radio base station 12 has a scheduler (control section) 301, a DL/UL configuration determining section 302, a DL subframe type determining section 303, a timing information generating section 304, a data signal generating section 305 and a control signal generating section 306.

The DL/UL configuration determining section 302 determines the DL/UL configuration to apply in TDD by the radio base station 12. For example, when there is change in DL/UL configuration, the DL/UL configuration determining section 302 notifies the scheduler 301 and the DL subframe type determining section 303 of changed DL/UL configuration. The function of the DL/UL configuration determining section 302 may be provided in the scheduler 301.

When there is change in DL/UL configuration, the DL subframe type determining section 303 determines the type of each DL subframe in a radio frame before change in DL/UL configuration. Specifically, the DL subframe type determining section 303 determines the type of each DL subframe based on the timing of feedback of a transmission acknowledgement signal of the DL subframe. For example, if the transmission acknowledgement signal can be fed back using a UL subframe in the same radio frame, the DL subframe type determining section 303 determines the DL subframe belongs to the first type (Type 1) and if the transmission acknowledgement signal is to be fed back using a UL subframe in a radio frame after change in DL/UL configuration, the DL subframe type determining section 303 determines the DL subframe belongs to the second type (Type 2) (see FIG. 6 mentioned above). Here, the second type may be further classified into two cases.

The scheduler (control section) 301 reconfigures the UL subframe to use in feedback of a transmission acknowledgement signal of each DL subframe, based on the feedback timing of the transmission acknowledgement signal. Specifically, the scheduler 301 controls to configure the transmission acknowledgement signal of the first-type DL subframe with the HARQ feedback timing applied to each radio frame before change in DL/UL configuration (see FIG. 8 mentioned above). In the meantime, as for a transmission acknowledgement signal of the second-type DL subframe, the scheduler 301 reconfigures a UL subframe for feedback based on the feedback range (feedback window) covered by the UL subframe after change in DL/UL configuration (see FIGS. 9 and 10 mentioned above).

In addition to control of the UL subframe for feedback of a transmission acknowledgement signal, the scheduler (control section) 301 performs scheduling of downlink user data to be transmitted on PDSCH, downlink control information to be transmitted on PDCCH and/or enhanced PDCCH (EPDCCH) and reference signals. Specifically, the scheduler 301 performs allocation of a radio resource based on feedback information (for example, CSI including CQI and RI) from each user terminal 20 and instruction information from the higher station apparatus 30.

The timing information generating section 304 generates information about feedback timing of a transmission acknowledgement signal (redesigned HARQ timeline) to be reconfigured in the scheduler 301 in accordance with change in DL/UL configuration. If the information about feedback timing is given by higher layer signaling (RRC signaling), it may be included in a data signal. If the information about feedback timing is given to the user terminal dynamically, it may be included in downlink control information. It also may be included in a broadcast signal.

The data signal generating section 305 generates a data signal (PDSCH signal) that is determined to be allocated to a radio resource by the scheduler 301. The data signal generated by the data signal generating section 305 is subjected to coding and modulation processing in accordance with the coding rate and modulation scheme determined based on CSI or the like from each user terminal 20. The control signal generating section 306 generates a control signal (PDCCH signal and/or EPDCCH signal) for a user terminal 20 that is determined to be allocated to each subframe by the scheduler 301.

Thus, by controlling the HARQ feedback timing in accordance with the type of a DL subframe before change in DL/UL configuration, it is possible to make full use of the existing (LTE Rel. 10) mechanism in radio frames before and after change in DL/UL configuration. In addition, by controlling the HARQ feedback timing in consideration of the feedback range covered by a UL subframe after change in DL/UL configuration, it is possible to perform HARQ feedback appropriately even for the above-mentioned second type (Type 2) case. Consequently, it is possible to suppress delay in feedback of a transmission acknowledgement signal or the like and also possible to allocate the feedback amount of transmission acknowledgement signals and so on distributely to UL subframes after change in DL/UL configuration.

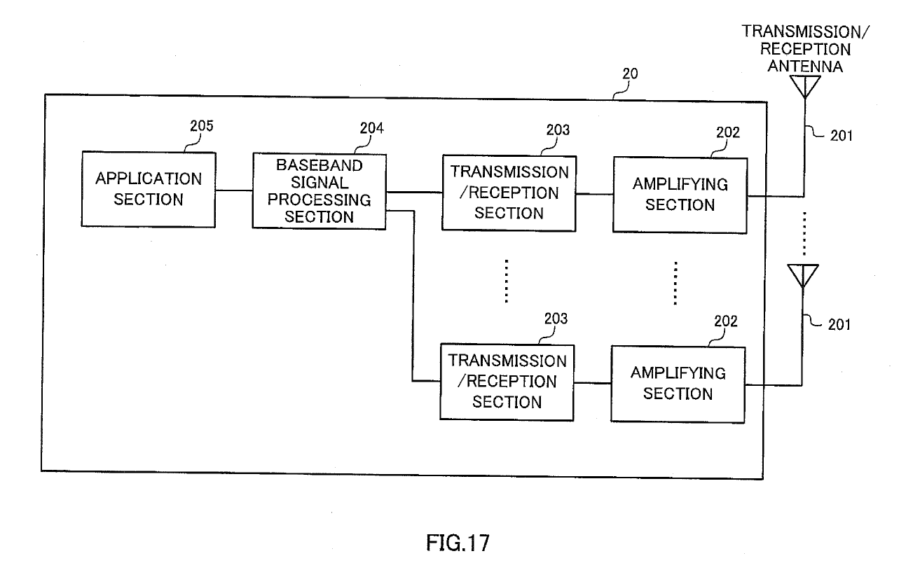

FIG. 17 is a diagram illustrating the overall configuration of the user terminal 20 according to the present embodiment. The user terminal 20 is configured to have a plurality of transmission/reception antennas 201 for MIMO transmission, amplifying sections 202, transmission/reception sections (reception sections) 203, a baseband signal processing section 204, and an application section 205.

As for the downlink data, radio frequency signals received by the transmission/reception antennas 201 are amplified in the amplifying sections 202, and then, subjected to frequency conversion and converted into baseband signals in the transmission/reception sections 203. These baseband signals are subjected to FFT processing, error correction coding, reception processing for retransmission control and so on in the baseband signal processing section 204. In this downlink data, downlink transmission data is transferred to the application section 205. The application section 205 performs processing related to higher layers above the physical layer and the MAC layer. In the downlink data, broadcast information is also transferred to the application section 205.

On the other hand, uplink user data is input from the application section 205 to the baseband signal processing section 204. In the baseband signal processing section 204, retransmission control (HARQ-ACK) transmission processing, channel coding, precoding, DFT processing, IFFT processing and so on are performed, and the resultant signals are transferred to the transmission/reception sections 203. In the transmission/reception sections 203, the baseband signals output from the baseband signal processing section 204 are subjected to frequency conversion and converted into a radio frequency band. After that, the frequency-converted radio frequency signals are amplified in the amplifying sections 202, and then, transmitted from the transmission/reception antennas 201. Each transmission/reception section 203 serves as a reception section configured to receive information about the subframe type given from the radio base station and so on.

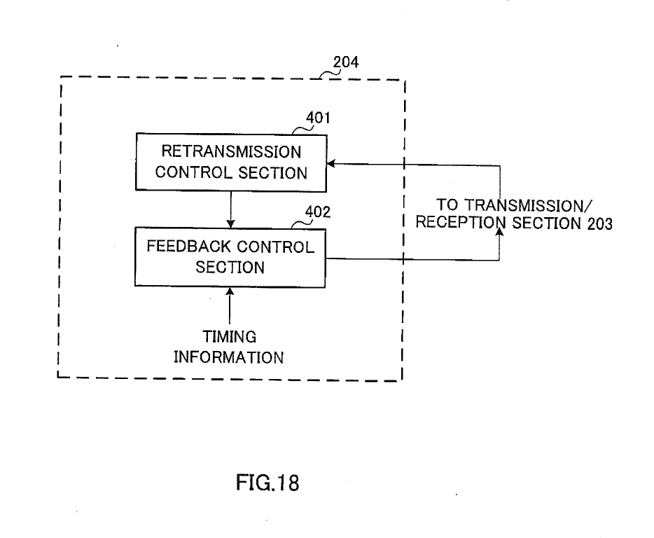

FIG. 18 is a diagram illustrating principal functional structures of the baseband signal processing section 204 provided in the user terminal 20. As illustrated in FIG. 18, the baseband signal processing section 204 of the user terminal 20 has at least a retransmission control section 401 and a feedback control section 402. As described above, the baseband signal processing section 204 also has functional sections to perform channel coding, precoding, DFT processing, IFFT processing and other processing.

The retransmission control section 401 determines whether a data signal (PDSCH signal) received via a DL subframe has been received properly or not and generates a transmission acknowledgement signal (ACK/NACK) based on a reception result. The feedback control section 402 controls feedback of the transmission acknowledgement signal generated in the retransmission control section 401 (for example, feedback timing or the like). Specifically, the feedback control section 402 allocates the transmission acknowledgement signal corresponding to each DL subframe to an appropriate UL subframe based on information about feedback timing given from the radio base station (redesigned HARQ timeline).

Therefore, when there is change in DL/UL configuration, the feedback control section 402 controls the HARQ feedback timing in accordance with the type of a DL subframe before change in DL/UL configuration. Specifically, as for a transmission acknowledgement signal of the above-described first-type DL subframe, the feedback control section selects a UL subframe for feedback based on the HARQ feedback timing applied to each radio frame before change in DL/UL configuration (see FIG. 8 mentioned above). On the other hand, as for a transmission acknowledgement signal of the above-described second-type DL subframe, the feedback control section 402 selects a UL subframe for feedback based on the feedback range (feedback window) covered by the UL subframe after change in DL/UL configuration (see FIGS. 9 and 10 mentioned above).

Up to this point, the present invention has been described in detail by way of the above-described embodiments. However, a person of ordinary skill in the art would understand that the present invention is not limited to the embodiments described in this description. The present invention could be embodied in various modified or altered forms without departing from the gist or scope of the present invention defined by the claims. Therefore, the statement in this description has been made for the illustrative purpose only and not to impose any restriction to the present invention.

The disclosure of Japanese Patent Application No. 2013-084036 filed on Apr. 12, 2013, including the specification, drawings, and abstract, is incorporated herein by reference in its entirety.

1. A radio base station that communicates with a user terminal by time division duplex and is capable of controlling change in DL/UL configuration, the radio base station comprising:
a determining section that determines feedback timing of a transmission acknowledgement signal of a DL subframe in a radio frame before change in DL/UL configuration; and
a control section that controls a UL subframe to use in feedback of the transmission acknowledgement signal of the DL subframe, based on the feedback timing,
wherein, when the transmission acknowledgement signal is to be fed back in a radio frame after change in DL/UL configuration, the control section reconfigures the UL subframe to use in feedback based on a feedback range covered by a UL subframe after change in DL/UL configuration.

2. The radio base station according to claim 1, wherein, when the transmission acknowledgement signal is to be fed back in the radio frame before change in DL/UL configuration, the control section maintains the feedback timing to use in the radio frame before change in DL/UL configuration.

3. The radio base station according to claim 1, wherein the feedback range is determined based on feedback timing to use for the radio frame after change in DL/UL configuration.

4. The radio base station according to claim 1, wherein the feedback range covered by the UL subframe is configured not to overlap a feedback range of any other UL subframe in the radio frame after change in DL/UL configuration.

5. The radio base station according to claim 4, wherein a starting point of the feedback range is a temporally first DL subframe among DL subframes corresponding to the UL subframe in the radio frame after DL/UL configuration.

6. The radio base station according to claim 5, wherein the feedback range of the UL subframe ranges from the starting point to a subframe just before a DL subframe that is a starting point of a feedback range corresponding to a UL subframe temporally next to the UL subframe.

7. The radio base station according to claim 1, wherein, when the transmission acknowledgement signal is to be fed back in the radio frame after change in DL/UL configuration, the determining section further determines a transmission direction of the subframe corresponding to the transmission acknowledgement signal.

8. The radio base station according to claim 7, wherein, when the transmission acknowledgement signal of the DL subframe is to be fed back in the radio frame after change in DL/UL configuration, a subframe corresponding to the transmission acknowledgement signal is a UL subframe and the DL subframe is not covered by any feedback range, the control section maintains the feedback timing to use in the radio frame before change in DL/UL configuration.

9. A user terminal that communicates by time division duplex with a radio base station capable of controlling change in DL/UL configuration, the user terminal comprising:
a generating section that generates a transmission acknowledgement signal of a downlink signal transmitted from the radio base station;
a reception section that receives feedback timing information that is provided from the radio base station with change in DL/UL configuration; and
a feedback control section that controls a UL subframe to use in feedback of the transmission acknowledgement signal, based on the feedback timing information,
wherein, when transmission acknowledgement signal is to be fed back in a radio frame after change in DL/UL configuration, the feedback control section allocates the transmission acknowledgement signal to the UL subframe that is determined based on a feedback range covered by a UL subframe after change in DL/UL configuration.

10. A radio communication method for a radio base station capable of controlling change in DL/UL configuration and a user terminal communicating with the radio base station by time division duplex, the radio communication method comprising the steps of:
in the radio base station,
determining feedback timing of a transmission acknowledgement signal of a DL subframe in a radio frame before change in DL/UL configuration; and
controlling a UL subframe to use in feedback of the transmission acknowledgement signal of the DL subframe, based on the feedback timing,
wherein, when the transmission acknowledgement signal is to be fed back in a radio frame after change in DL/UL configuration, the UL subframe to use in feedback is reconfigured based on a feedback range covered by a UL subframe after change in DL/UL configuration.
